(19) United States
(12) Patent Application Publication
(10) Pub. No.: US 2006/0153110 A1
(43) Pub. Date: Jul. 13, 2006

(54) Simplex reverse link in a communication network

(76) Inventors: William K. Morgan, Marengo, IL (US); Daniel J. Declerck, Lake Barrington, IL (US)

Correspondence Address: POSZ LAW GROUP, PLC, 12040 SOUTH LAKES DRIVE, SUITE 101, RESTON, VA, 20191, US

(21) Appl. No.: 11/024,055

(22) Filed: Dec. 28, 2004

(51) Int. Cl. H04B 7/00

(52) U.S. Cl. 370/310

(57) ABSTRACT

A controller (101, 103) provides forward links (109) and reverse links (111a, 111b, 111c) for use in communication with communication devices (107). The controller (101, 103) has receivers including a first receiver and a second receiver, and transmitters. A processor of the controller (101) assigns one of transmitters as a forward link (109) and the first receiver (111a) as a reverse link, together forming at least one duplex link. Also, the processor assigns the second receiver as another reverse link (111b), independent of an assignment of a transmitter, to form a simplex reverse link.

### FIELD OF THE INVENTION

The present invention relates in general to wireless communication units and wireless networks, and more specifically to reverse links used in connection with wireless communication.

### BACKGROUND OF THE INVENTION

A communication device such as a mobile cellular telephone generally includes a two-way radio transceiver, comprising both a transmitter and a receiver, to communicate with various base stations in a communication network as the communication device travels through a coverage area. As the communication device moves through the area, the strength of the transmitted signal or the received signal between the communication device and a particular base station may fall below a useable level. Other fading of the signals and/or interference with the signals may also inhibit a clear connection. If either the base station or the communication device fails to receive a sufficient signal, the call can be prematurely ended, resulting in what is commonly known as a dropped call.

One way to reduce the prevalence of dropped calls is to utilize diversity, for example by exchanging signals through multiple pairs of receivers and transmitters—each pair forming a duplex link—at the base station. The base station can then utilize a best signal from a duplex link.

While traversing the coverage area, the communication device can request the addition of a new base station to a set it maintains of active base stations. The new base station correspondingly allocates a pair comprising a transmitter and receiver to be utilized as a forward link and a reverse link, respectively, as a duplex link with the communication device.

If the communication device is transmitting at an appropriate power level, yet the signal quality received at the base station is near a minimum acceptable level, the base station can request the communication network to perform a handoff. The surrounding base stations can measure the signal received from the communication device, and one of the new base stations with a sufficiently strong signal and available physical channels provides a duplex link, and communication with the communication device can be handed off to the new base station, which will then serve the communication device. The former base station can continue to provide a duplex link for diversity, or drop the duplex link that corresponded to the communication device, thereby freeing up a forward link and a reverse link.

### BRIEF DESCRIPTION OF THE DRAWINGS

The accompanying figures where like reference numerals refer to identical or functionally similar elements and which together with the detailed description below are incorporated in and form part of the specification, serve to further illustrate various exemplary embodiments and to explain various principles and advantages in accordance with the present invention.

FIG. 1 is a diagram illustrating a simplified and representative environment associated with a communication device and an exemplary wireless network in accordance with various exemplary embodiments;

FIG. 2 is a block diagram illustrating portions of an exemplary controller in an exemplary communication network, arranged for providing simplex reverse links in accordance with various exemplary embodiments;

FIG. 3 is an exemplary flow diagram illustrating an exemplary communication flow in accordance with various embodiments;

FIG. 4 is a flow chart illustrating an exemplary procedure for providing forward and reverse links in accordance with various exemplary and alternative exemplary embodiments; and

FIG. 5 is an exemplary flow diagram illustrating an alternative exemplary communication flow in accordance with various embodiments.

### DETAILED DESCRIPTION

In overview, the present disclosure concerns communication networks, such as an enterprise network, a cellular Radio Access Network, or the like, often associated with, e.g., wireless communications devices or units, often referred to as communication units, such as cellular telephones or two-way radios and the like having the ability to send and/or receive communications, associated with a communication network. Such communication networks may further provide services such as voice and data communications services. More particularly, various inventive concepts and principles are embodied in communication networks, portions thereof, and methods therein for providing forward and reverse links associated with a communication device in a communication network.

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as one or more processors and software therefore or application specific ICs, optionally in communication with conventional hardware components. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by various exemplary embodiments.

By way of terminology, a link from a transmitter of a base station to a receiver of a communication device is called a forward link, whereas a link from a transmitter of the communication device to a receiver of the base station is referred to as a reverse link. Modern communication networks utilize a forward and a reverse link as a pair, referred to herein as a duplex link. Consider, as a specific example, a CDMA (code division multiple access) standard known as IS-95 that defines two links, which it refers to as channels, including a first radio frequency (RF) channel from the base station to the communication device (forward link or downlink), and a second RF channel with a different frequency from the communication device to the base station (reverse link or uplink). Typically, the forward and the reverse portions of a duplex link in this and other communication standards occupy different communication spectrums, have different characteristics, and can be used for different purposes.

Conventional communications can make use of diversity, such as spatial diversity, by using multiple duplex links at the base station in connection with a variety of communication functions, e.g., receipt of communications from the device and CDMA handoffs, including a soft handoff of multiple duplex links between two different base stations, and/or a softer handoff of multiple duplex links within the same base station.

A strength or quality of a signal on the overall duplex link typically is included as a measurement of the forward link and is provided to the communication network by the communication device, e.g., in a pilot strength measurement message (PSMM). A strong or high quality signal on a forward link does not necessarily correlate to a strong or high quality reverse link on the same duplex link. Moreover, there can be a small but significant portion of time when the forward link and the corresponding reverse link in a duplex link experience vastly different fading. The measurement of the signal on the forward link consequently can be an inaccurate reflection of the strength of the signal on the reverse link with which it is paired.

Although additional duplex links can be used to increase diversity, this may as a practical matter unnecessarily increase interference caused by the additional forward link portions of the duplex links.

As further discussed herein below, various inventive principles and combinations thereof are advantageously employed to provide reverse link diversity and to improve RF (radio frequency) quality. Advantageously, providing reverse link diversity can avoid an increase of interference caused by adding forward links. Moreover, adding reverse link diversity can assist in decreasing the number of dropped calls that result from inaccurate measurement of the reverse link signal strength in a duplex link. Advantageously, the combination of reverse links can improve quality which allows a communication device to transmit at a lower power, thus increasing its battery life and reducing system interference and the like. Reverse link diversity can be accommodated, as described further in detail herein, in connection with the provision of simplex reverse links.

Further in accordance with exemplary embodiments, one or more reverse links can be provided by a base station independent of providing forward links, thereby forming simplex reverse links. The simplex reverse links can thereby be utilized to provide diversity. This can be particularly useful in systems such as where the RF environment is hostile and/or where there may be significant differences in forward link and reverse link characteristics. In addition, one or more embodiments can be utilized in radio frequency (RF) systems where the forward link frequency and the reverse link frequency are separated by a considerable range (e.g., frequency division duplex CDMA), so that different RF conditions and fading profiles occur. Reverse link diversity can be independent of and not limited by the forward links, even in RF systems which are forward link limited (such as cdma2000®).

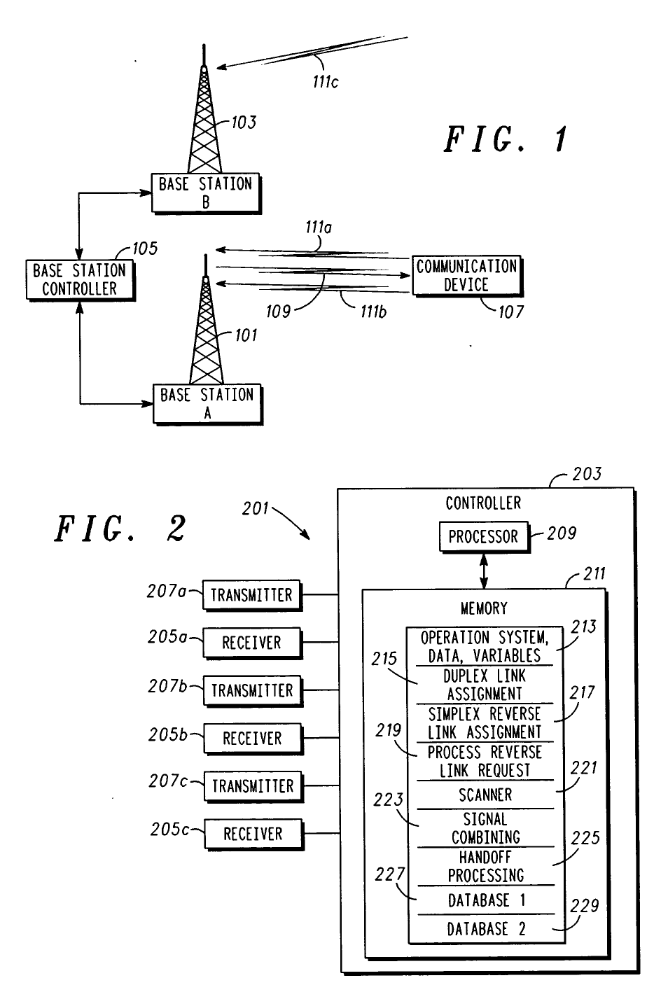

Referring now to FIG. 1, a diagram illustrating a simplified and representative environment associated with a communication device and an exemplary wireless network in accordance with various exemplary embodiments will be discussed and described. In the illustrated example, a first base station A 101 and the communication device 107 communicate utilizing a duplex link. The duplex link consists of a forward link 109 and a reverse link 11a. Additionally, the base station A 101 and the communication device 107 communicate utilizing a simplex reverse link 111b. A base station controller 105 provides control and coordination between other network elements, represented here by a base station B 103. In the present example, the base station B 103 has allocated a receiver to be a reverse link 111c. As the communication device 107 traverses from base station to base station, one or more reverse links 111b, 111c can be utilized as a simplex reverse link to provide diversity in communication with, e.g., the communication device 107.

The base stations A and B 101, 103, although illustrated in simplified form, can have multiple receivers and transmitters, conventional channel elements, conventional backhaul facilities, and other components that will be appreciated by one of skill. Handling of diversity by utilizing simplex reverse links can be performed independently of handling of diversity by utilizing duplex links.

The receivers and associated hardware and software can decode communications received over a reverse link, whether part of a duplex link or formed from a simplex reverse link, in the usual manner. A result of decoding the reverse link can be combined with another signal from the communication device at any of various physical or logical layers, as is known in the art, or the resultant decoded and combined signal can be selectively chosen, e.g., on a timeframe basis as would be appropriate for a soft handoff using a simplex reverse link.

Referring now to FIG. 2, a block diagram illustrating portions of an exemplary controller in an exemplary communication network arranged for providing simplex reverse links in accordance with various exemplary embodiments will be discussed and described. A base station 201 may include one or more controllers 203, one or more receivers 205a-c and transmitters 207a-c for communication with communication devices over a communication network, one or more processors 209, one or more memories 211, and various other functions, e.g. a communication interface to other network entities that will be appreciated by those of ordinary skill.

The processor 209 may comprise one or more microprocessors, one or more digital signal processors and/or one or more ASICs (application specific integrated circuit). The memory 211 may be coupled to the processor 209 and may comprise a read-only memory (ROM), a random-access memory (RAM), a programmable ROM (PROM), an electrically erasable read-only memory (EEPROM), a magnetic or optical memory, and/or the like. The memory 211 may include multiple memory locations for storing, among other things, an operating system, data and variables 213 for programs executed by the processor 209; computer programs for causing the processor to operate in connection with various functions such as duplex link assignment 215, simplex reverse link assignment 217, processing reverse link requests 219, a scanner 221, signal combining 223, handoff processing 225, and/or other processing (not illustrated); a database 227 of, e.g., information concerning other base stations and/or signal strengths from various communication devices; and a database 229 for other information used by the processor 209. The computer programs when, executed by the processor, direct the processor 209 in controlling the operation of the base station 201.

The processor 209 can be programmed to provide forward links and reverse links for use in communication with communication devices. The receivers 205a-c can include one or more first receivers and one or more second receivers. The transmitters 207a-c can include one or more transmitters, that can be utilized to form duplex links.

The processor 209 may be programmed to perform duplex link assignment 215. An available forward link and an available reverse link can be utilized as a pair to form a duplex link. Accordingly, the processor 209 can assign one or more transmitters as a forward link and one or more receivers as a reverse link, together forming one or more duplex links. A communication device that is expected to transmit to the base station can be informed of the availability (e.g., address) of the forward link.

The processor 209 can be programmed to perform simplex reverse link assignment 217. Accordingly, the processor can assign one or more receivers in support of a reverse link, independent of an assignment of a transmitter, to form at least one simplex reverse link. The simplex reverse link can be utilized to listen for transmissions from a particular communication device.

Moreover, the processor 209 can determine which of the available receivers to assign as the reverse link to be utilized in, e.g., the simplex reverse link. The assigning of the reverse link as the simplex reverse link can be performed responsive to the determination.

According to one or more embodiments, the base station can measure the quality of signals received from the communication device, e.g., at transmitter/receiver antennas on sectors other than an active set of duplex link sectors on the base station, for example, through the use of the scanner, and can allocate additional receive paths if any simplex reverse links are found to be beneficial. In accordance with the one or more embodiments, the determination of which receiver to assign can include performing a determination of a quality of a signal received from a communication device, judging whether the quality is acceptable, and performing the second assignment as the simplex reverse link if the quality is acceptable. Acceptable quality can be determined as in accordance with known systems, e.g., by comparison of measured signal strength against a threshold.

In accordance with alternative embodiments, the receivers and the transmitters can form sectors. The duplex link can be utilized in communication with a communication device in one or more of the sectors. The determination of which receiver to assign can include judging the sector from which the at least one second receiver is to be assigned. For example, where the simplex reverse link is to be assigned to a communication device, it may be desirable to utilize a reverse link from a sector that is not currently used by the communication device.

As another alternative, the determination of which receiver to assign can include performing a determination of a communication device with a signal of acceptable quality in a local area. The acceptability of signal quality can be determined in accordance with known techniques. If the signal quality is acceptable, the reverse link can be assigned to the communication device.

The processor 209 can be programmed to receive and process reverse link requests 219, e.g., from a base station and/or a base station controller. This is appropriate, for example, where a neighboring base station has insufficient reverse links and/or anticipates a handoff. Accordingly, the assigning of the reverse link to a simplex reverse link can be responsive to a receipt of a reverse link request from a base station. The reverse link request can comprise transmission and reception of various communications between the base stations, base station controller, and/or communication device, in order to accomplish the request, and which can be suitably adapted for use with, e.g., known protocols. Alternatively, the processor 209 can be programmed to receive and process duplex link requests, e.g., from a base station and/or a mobile switching center. This is appropriate, for example, where the neighboring base station has determined the need for and/or anticipates a handoff. Accordingly, the assigning of the reverse link can be responsive to a receipt of a duplex link request from a base station which may occur if the base station has insufficient forward link resources to form the duplex link. The duplex link request can comprise transmission and reception of various communications between the base stations, base station controllers, and/or communication device, in order to accomplish the request, and which can be suitably adapted for use with, e.g., known protocols.

In accordance with one or more embodiments, the processor 209 can be programmed to provide a scanner 221 function that actively determines signal quality. The scanner function in the processor 209 can be provided in connection with other hardware elements, e.g., one or more CDMA channel elements acting in a receiver mode, to form a scanning channel element.

The scanning channel element is provided with information as to which communication devices are in the local area, e.g., by a list of electronic serial numbers of the communication devices provided from the base station controller. A communication network typically includes fixed network equipment, e.g., the base station controller, that can coordinate overall operation of the communication network; the fixed network equipment can monitor cellular calls, track locations of communication devices traveling in the communication network, arrange handoffs, etc. The fixed network equipment can provide the processor 209, and hence the scanning channel element, with the list of electronic serial numbers of relevant communication devices.

The scanning channel element can periodically review the list of serial numbers of relevant communication devices, and scan for listed communications devices in the local area with sufficient signals. In order to accomplish this, the scanning channel element can be configured as a reverse simplex link for a short duration of time for each communication device on the list. When the scanning channel element detects a sufficient signal from a communication device, e.g., having an Ec/Io (Energy per chip over normalized interference) or Eb/No (Energy-per-bit to noise density ratio) above a threshold, the scanning channel element can send a request to an appropriate processing layer in the processor 209 requesting that the reverse link the communication device was on be utilized in connection with a handoff, e.g., a soft simplex handoff. Any forward link can be disregarded at the moment since it might not be sufficiently strong for the communication device to request or use and therefore just adds interference to the network. If in the future the communication device determines that the forward link strength to be sufficient quality, the forward link can be added at that time and, if desired, the simplex reverse link can be turned into a standard duplex link (as further described herein). Alternatively, the simplex reverse link can be dropped at an appropriate time, e.g., when the reverse link goes to an all erasure state for a threshold amount of frames. The scanner can limit its scan to sectors where the communication device is not in an active set sector (e.g., a sector with duplex link assigned to the communication device). Accordingly, the controller 203 can include a scanner 221 to measure the quality, where the communication device is not in an active set sector.

Alternatively, one or more embodiments, the processor 209 can be programmed to determine signal quality from existing information. For example, the quality can be determined from information representative of a plurality of communication devices retrieved from storage. The communication network conventionally collects and stores information from either the communication network or communication devices relating to, among other things, quality of the signals. Such information can be stored at the base station and or at the base station controller, from where it can be made available to base stations, in accordance with current conventions.

Furthermore, the processor 209 can be programmed to combine signals 223, e.g., where one or more duplex links and one or more simplex reverse links are in communication with a communication device. The received signals from multiple receivers can be combined as is conventional for signal diversity. This is helpful in, e.g., reducing fading effects. The base station can combine information from the extra receive paths provided by the simplex receive link(s) to obtain better quality information. For example, at a frame level, the best quality frames can be selected. As another example, at the application specific integrated circuit (ASIC) level, the information is combined and the best quality information is selected. Accordingly, the processor 209 can be programmed for combining signals received from a communication device on the receiver(s) of the duplex link(s) and the receiver(s) of the simplex reverse link(s).

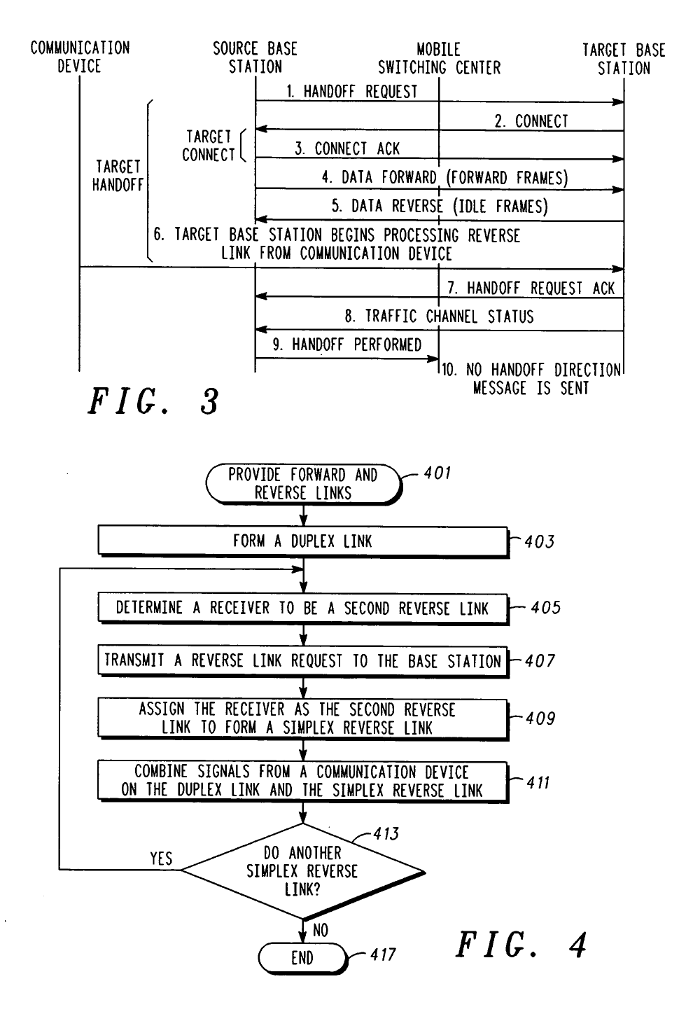

According to one or more embodiments, handoff processing 225 can further be performed under control of the processor 209 Examples of message flow to accomplish handoff processing control are discussed in connection with the embodiments illustrated in FIG. 3 below. Where the duplex link(s) is utilized in communication with a communication device, the processor 209 can facilitate continued communication with the communication device utilizing the duplex link(s) and the simplex reverse link(s). Handoffs can include, e.g., a hard handoff, a soft handoff, and/or a softer handoff. Note that the simplex reverse link and the duplex link can be on the same sector of a base station, on different sectors of the base station, or on different base stations.

In addition, the base station can receive a handoff request from another base station, and can provide a simplex reverse link to be utilized in connection with the handoff. Once the handoff is underway or is fully performed, the simplex reverse link can be transformed into a duplex link, e.g., by adding a forward link. Accordingly, the processor 209 can facilitate, responsive to a handoff, forming one or more second duplex links utilizing the receiver (that formed the simplex reverse link).

In accordance with one or more embodiments, the processor 209 can be programmed for a variety of simplex reverse link functionality, examples of which follow.

Optionally, reverse link diversity can be added on a neighboring base station, even if a forward link cannot be added due to forward link interference limits, Walsh code limit, where the number of pilots above a threshold exceed a maximum active set size, lack of available forward link transmitters, or other limitations. Accordingly, the processor 209 can facilitate determining one or more other receivers to be assigned to form one or more second simplex reverse links, wherein the other receiver(s) is determined to be on a base station other than the present base station. Also, the processor 209 can cause a reverse link request to be transmitted to the other base station. The other base station can then determine and assign the simplex reverse link. This can be used, for example, in connection with a handoff to the other base station.

In addition, one or more embodiments provide that simplex reverse links are generally provided when there are a sufficient number of available reverse links. Notification regarding the availability of simplex reverse links can be provided, indicating whether or not there are available simplex reverse links. Accordingly, the processor 209 can cause a transmission of a notification about an availability of the additional simplex reverse link(s) to a base station. Similarly, the processor can facilitate transmitting a notification about an availability of an additional forward link and an additional reverse link.

To ease congestion hot spots (e.g., areas of high traffic density), communication network operators typically deploy various carriers in a given geographic region. As a communication device moves toward an edge of coverage for a particular carrier, a conventional process using a pilot beacon can be employed at the base station, e.g., a simple forward link transmitter allowing a communication device to sense when it is appropriate to move from the radio frequency (RF) carrier signal that is no longer serving its area to an RF carrier signal that can continue to service the communication device. For a communication device operating at the edge of coverage, it can be advantageous to utilize the simplex reverse link discussed herein. One or more embodiments thus can gain benefits such as reduced interference, as mentioned previously, until a hard handoff can be executed to a carrier with continuous coverage.

Referring now to FIG. 3, an exemplary flow diagram illustrating an exemplary communication flow in accordance with various embodiments will be discussed and described. One or more embodiments can be employed in connection with CDMA standard procedures. For example, soft/softer handoff procedures can be modified along the lines described below. This exemplary embodiment is discussed in connection with CDMA interoperability specification (IOS) v.4.2, although it will be appreciated that similar modifications can be made to other versions of CDMA specifications and to other standard procedures as well.

FIG. 3 illustrates addition of a simplex reverse link in connection with a soft/softer handoff. Soft/softer handoff simplex reverse link addition can include the creation of new connections which are referred to in IOS v.4.2 as “A3 connections”, and/or the addition of base stations or cells to existing connections, e.g., A3 connections.

In overview, a target handoff can be performed from a source base station to a target base station, including a handoff request 1, a connect response 2, a connect acknowledge 3, a data forward 4, and a data reverse 5. The connect response 2 and the connect acknowledge 3 may be subject to a target connect timer. The communication device 6 can then be in communication with the target base station. The target base station can transmit a handoff request acknowledge 7, a traffic channel status message 8, and the handoff is performed (i.e., accomplished) 9 message. The handoff performed message is transmitted to a mobile switching center. It is not necessary to send a handoff direction message 10.

In more detail, the source base station determines that one or more sectors at the target base station are desired to support an ongoing communication, e.g., a telephone call, with the communication device, in a soft/softer handoff. The source base station transmits 1 the handoff request, such as an A7 handoff request defined in the IOS or other standard procedures. A timer, illustrated by the “target handoff” time in FIG. 3, can be initiated. The source base station may or may not be aware of any forward link availability at the target base station.

The target base station can initiate a connection with the source base station. The target base station and source base station can communicate via the network, including one or more base station controllers. The target base station can transmit the connect notification 2 to the source base station, such as an A3 connect defined in the IOS. A single handoff request message can result in one or more connections being established, although in the IOS, each connection is expected to use a separate connect message. The present example illustrates a single connection being established.

The source base station can reply with the connect acknowledge 3 sent to the target base station, to complete the connection or to acknowledge the addition of cells to an existing connection.

The source base station can begin to send forward frames to the target base station. The target base station can receive the forward frames from the source base station, but is insufficiently connected to the communication device to be able to transmit the forward frames to the communication device. The source base station can transmit the data forward 4, for example as a type of A3-CEData Forward message, e.g., an A3-IS-95 FCH Forward, A3-IS-2000 FCH Forward, A3-IS-2000 DCCH Forward, or A3-IS-2000 SCH Forward message. Accordingly, the target base station can enable reception of the reverse link path from the communication device.

The target base station can begin to send reverse idle frames, for example beginning when the first forward frame is received from the source base station. The reverse frames can contain timing adjustment information in order to achieve synchronization. The target base station can transmit the data reverse 5, such as a type of A3-CEData Reverse message, e.g., an A3-IS-95 FCH Reverse, A3-IS-2000 FCH Reverse, A3-IS-2000 DCCH Reverse, or A3-IS-2000 SCH Reverse message.

The target base station can begin processing data received on a reverse link from the communication device 6. The target base station can send a handoff request acknowledge message to the source base station to indicate the successful addition of the simplex reverse link. The handoff request acknowledge 7 to the source base station can be, for example, an A7 handoff request acknowledge as defined in the IOS. The source base station can stop the target handoff timer, when the handoff request acknowledge is timely. Optionally, an availability of forward physical channel radio resource can be indicated through a cell identifier list transmitted from, e.g., the base station controller, to appropriate base stations.

If the source base station has selected to be notified of the start of transmission and reception at the target base station, then when the source and target base stations have synchronized the traffic sub-channel, the target base station can reply with an appropriate message. The target base station can transmit the traffic channel status message 8 to the source base station, e.g., an A3 traffic channel status message as defined in the standard. This optional message can occur any time after the source base station begins to send forward frames to the target base station.

The handoff performed 9 message can be sent from the source base station to the mobile switching center. In the present example, as compared with the existing IOS, it is noted that the handoff direction message normally sent to the communications device was omitted 10. The handoff performed message can be sent any time after the handoff completion message is received by the base station.

The above-described signaling, or similar, can be helpful during call set up for origination into a soft handoff.

Similar signaling can occur in a case where a target base station (or cell of a base station) has no forward link available. This situation may be encountered for example where there is a lack of Walsh codes, equipment failure, etc. If a forward link becomes available, additional signaling can inform the network that the additional forward link can now be added.

IOS (interoperability specification) signaling similarly can be performed when resources are not available. For example, when a resource does become available, another signaling sequence can occur, similar to the foregoing, except the first message can be an autonomously generated connect (e.g., starting with the second message 2) indicating a change in availability of forward physical radio resources.

Similar signaling can be utilized in connection with 1× standards, e.g., 1XEV-DO, 1XEV-DV, and other standards adaptable to a concept of a reverse link soft handoff and/or simplex reverse links. Signaling procedures adapted from the above examples and/or foregoing description can be used, except that handoff requests are instead referred to by the standard specific names, e.g., “active set update requests”, “request acknowledges,” etc.

Accordingly, sectors of a base station involved in a forward link soft handoff with a particular communication device may be different from those that provide the highest reverse link performance. The base station can measure the received signal quality of the communication device, e.g. at each of the receivers at sectors other than the active set sectors on the particular base station and can add additional reverse links if any are found to be beneficial. This can be particularly effective in six-sectored base stations in which the RF environment is hostile.

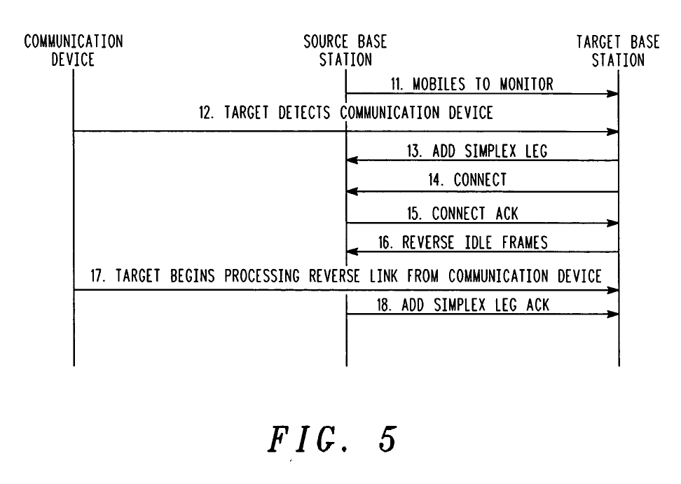

Referring now to FIG. 4, a flow chart illustrating an exemplary procedure 401 for providing forward and reverse links for use in communication with a communication device, in accordance with various exemplary and alternative exemplary embodiments will be discussed and described. The procedure can advantageously be implemented on, for example, a processor of a base station, described in connection with FIG. 2, another fixed network infrastructure device, or other apparatus appropriately arranged. The procedure can be provided on a computer-readable medium, where the computer-readable medium stores instructions that can be executed by a computer. The instructions can implement, e.g., a computer-implemented method for managing a communication environment for communicating with communication devices utilizing duplex links, where a duplex link includes a forward link corresponding to a transmitter and a reverse link corresponding to a receiver.

The procedure can include forming a duplex link 403. A duplex link can be formed, including assigning a transmitter of the several transmitters of one (or more) of the base stations as a forward link, and a receiver of the several receivers on the base station as a reverse link, together forming a duplex link in communication with a communication device. More than one duplex link can be formed. Conventionally, the duplex links include a reverse link and a forward link. Duplex links can be added and dropped as desired.

Also, the procedure can include determining 405 a receiver which is to be used as a reverse link, e.g., for use in connection as a simplex reverse link. The procedure can provide for determining which receiver of the several receivers is to be assigned as the reverse link (used for the simplex reverse link), including performing a determination of a quality of a signal received from the communication device, and judging whether the quality is acceptable. The determination of signal quality and acceptability thereof is described above. The assigning as the reverse link can be responsive to the quality. Accordingly, where the signal quality of a particular reverse link is unacceptable, it is possible that other reverse links can be utilized for the simplex reverse link.

The quality of the signal can be determined in various ways. As an example, information representative of the quality can be retrieved from storage, as described previously. It is possible that the communication device is in communication with one or more receivers that are not in an active set sector (an active set of duplex links comprising sectors or base stations that are currently active with respect to a particular communication device).

As another example, the quality can be determined by scanning the communication device to measure the quality, where the communication device is in communication with one or more receivers that are not in the active set sector.

Further, one or more embodiments of the procedure can include transmitting 407 a reverse link request to one or more other base stations to request an assignment of one or more simplex reverse links on the other base station(s).

The procedure can provide for assigning 409 the receiver (as determined above) as a second reverse link, to be used in forming a simplex reverse link. The procedure can assign, if the quality is acceptable, the second receiver as the second reverse link, independent of an assignment of a transmitter, to form a simplex reverse link in communication with the communication device.

Furthermore, the simplex reverse link that is in communication with a communication device can be transformed into a duplex link, e.g., in response to a handoff or when the current duplex link quality falls below an acceptable level. The procedure can provide a second duplex link to communicate with the communication device, the second duplex link utilizing the simplex reverse link.

In addition, the simplex reverse link can be assigned to a communication device. The simplex reverse link can then receive communications from the particular communication device. A communication can be transmitted to the communication device on a duplex link; and a signal from the communication device can be received on the at least one simplex reverse link. Communications received on the simplex reverse link can be utilized together with the typical communications from a duplex link to provide diversity and enhance communication quality.

The procedure can include combining 411 signals from a communication device on the duplex link and the simplex reverse link, as explained in detail above. The signal can be received on the simplex reverse link and the reverse link of the duplex link, and the signals received from the communication device on the simplex reverse link and the reverse link of the duplex link can be combined.

The procedure can loop, e.g., by determining whether another simplex reverse link can be created 413. For example, if there are available receivers not needed for duplex links, a simplex reverse link can be created. If another simplex reverse link should be created, the procedure can loop back to determine 405 a receiver to be another reverse link. Otherwise, if no further simplex reverse links are determined to be assigned, the procedure can end 417.

Referring now to FIG. 5, an exemplary flow diagram illustrating an alternative exemplary communication flow in accordance with various embodiments will be discussed and described. A source base station can determine that one or more communication devices are to be monitored by the target base station containing a scan receiver. The source base station can transmit a message 1 containing, e.g., electronic identifiers of the communication devices such as an electronic serial number, a public long code mask, or the like.

The target base station can detect a signal from a communication device 12 previously identified in the mobiles to monitor message, if the signal is of sufficient receive quality. The target base station can transmit a simplex let request message 13 to the source base station requesting that a simplex leg be added to an existing call. The target base station can initiate a connection, e.g., an A3 connection, by sending a connect message 14, e.g., an A-3 connect message to the communication device with the electronic identifier. The source base station can reply with a connect acknowledge 15 message, e.g., an A3-connect acknowledge, to complete the A3 connection or to acknowledge the addition of a cell to an existing A3 connection.

The target base station can begin to send reverse idle frames 16. The target base station can then begin processing the reverse link of the communication device 17. This can include, e.g., demodulating and decoding of RF link frames from the communication device. Reverse link bearer frames can be created as a result. The source base station can transmit a notification to the target base station that the simplex leg has been successfully added to the call 18.

In accordance with the foregoing, one or more embodiments can provide a benefit to cellular communication networks, e.g., CDMA networks, in connection with soft handoff links. Such benefits can be experienced, for example, at the edges of a communication network where a configuration of carrier frequency coverage terminates, or due to insufficient forward traffic channel resources which can be caused by hardware outages, lack of Walsh codes, etc.

As future communication networks, third generation and beyond, add higher speed reverse links, stability and reliability enabled by one or more embodiments can be more desirable.

Although examples are provided in connection with CDMA communication networks, it should be understood that the concepts can be extended to other communication networks. For example, independent forward and reference links can be applied to bearer paths within radio access networks (RAN), where bearer link independence may be beneficial for, e.g., providing more efficient usage of network resources.

It should be noted that the term communication device may be used interchangeably herein with communication unit, subscriber unit, wireless subscriber unit, wireless subscriber device or the like. Each of these terms denotes a device ordinarily associated with a user and typically a wireless mobile device that may be used with a public network, for example in accordance with a service agreement, or within a private network such as an enterprise network. Examples of such units include personal digital assistants, personal assignment pads, and personal computers equipped for wireless operation, a cellular handset or device, or equivalents thereof provided such units are arranged and constructed for operation in different networks.

The communication systems and communication units of particular interest are those providing or facilitating voice communications services and/or data and/or messaging services over cellular wide area networks (WANs), such as conventional two way systems and devices, various cellular phone systems including digital cellular, CDMA (code division multiple access) and variants thereof, GSM (Global System for Mobile Communications), GPRS (General Packet Radio System), 2.5G and 3G systems such as UMTS (Universal Mobile Telecommunication Service) systems, Internet Protocol (IP) Wireless Wide Area Networks like 802.16, 802.20 or FLASH OFDM, integrated digital enhanced networks and variants or evolutions thereof.

Furthermore the wireless communication units or devices of interest may have short range wireless communications capability normally referred to as WLAN (wireless local area network) capabilities, such as IEEE 802.11, Bluetooth, or Hiper-Lan and the like advantageously using CDMA, frequency hopping, OFDM (orthogonal frequency division multiplexing) or TDMA (Time Division Multiple Access) access technologies and one or more of various networking protocols, such as TCP/IP (Transmission Control Protocol/Internet Protocol), UDP/IP (Universal Datagram Protocol/Internet Protocol), ATM (Asynchronous Transfer Mode) or other protocol structures. Alternatively the wireless communication units or devices of interest may be connected to a LAN using protocols such as TCP/IP, UDP/UP, or ATM via a hardwired interface such as a cable and/or a connector.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A controller providing forward links and reverse links for use in communication with communication devices, comprising:
a plurality of receivers including at least one first receiver and at least one second receiver, and a plurality of transmitters including at least one transmitter;
a processor, the processing being configured to facilitate:
first assigning the at least one transmitter as at least one forward link and the at least one first receiver as at least one first reverse link, together forming at least one duplex link; and
second assigning the at least one second receiver as at least one second reverse link, independent of an assignment of a transmitter, to form at least one simplex reverse link.

2. The controller of claim 1, wherein the processor is further configured for combining signals received from a communication device on the at least one first receiver of the at least one duplex link and the at least one second receiver of the at least one simplex reverse link.

3. The controller of claim 1, wherein the processor is further configured for determining the at least one second receiver of the plurality of receivers to be assigned as the at least one second reverse link, wherein the second assigning is performed responsive to the determining.

4. The controller of claim 3, wherein the determining includes performing a determination of a quality of a signal received from a communication device, judging whether the quality is acceptable, and performing the second assigning if the quality is acceptable.

5. The controller of claim 4, further comprising a scanner to measure the quality, where the communication device is not in an active set sector.

6. The controller of claim 4, wherein the quality is determined from information representative of a plurality of communication devices retrieved from storage.

7. The controller of claim 3, wherein the plurality of receivers and the plurality of transmitters form a plurality of sectors; wherein the at least one duplex link is utilized in communication with a communication device in at least one of the plurality of sectors; and wherein the determining includes judging one of the sectors from which the at least one second receiver is to be assigned.

8. The controller of claim 3, wherein the determining includes performing a determination of a communication device with a signal of acceptable quality in a local area, and the at least one second reverse link is further assigned to the at least one communication device.

9. The controller of claim 1, wherein the processor is further configured to facilitate determining at least one other receiver to be assigned to form at least a second simplex reverse link, wherein the at least one other receiver is determined to be on a base station, and to facilitate transmitting a reverse link request to the base station.

10. The controller of claim 1, wherein the assigning is responsive to a receipt of a reverse link request from a base station.

11. The controller of claim 1, wherein the processor is further configured to facilitate transmitting a notification about an availability of the at least one second reverse link to a base station.

12. The controller of claim 1, the plurality of transmitters including at least one second transmitter, the at least one second transmitter being assigned as at least one second forward link; wherein the processor is further configured to facilitate transmitting a notification about an availability of the at least one second forward link and the at least one second reverse link.

13. The controller of claim 1, wherein the at least one duplex link is utilized in communication with a communication device, wherein the processor is further configured to facilitate continuing to communicate with the communication device utilizing the at least one duplex link and the at least one simplex reverse link.

14. The controller of claim 1, wherein the processor is further configured to facilitate, responsive to a handoff, forming at least a second duplex link utilizing the at least one second receiver.

15. A method of providing forward links and reverse links for use in communication with a communication device, comprising:
first assigning at least one transmitter of a plurality of transmitters on at least one base station as at least one forward link, and at least one first receiver of a plurality of receivers on the at least one base station as at least one first reverse link, together forming at least one duplex link in communication with a communication device;
determining at least one second receiver of the plurality of receivers to be assigned as at least one second reverse link, including performing a determination of a quality of a signal received from the communication device, and judging whether the quality is acceptable; and
second assigning, if the quality is acceptable, the at least one second receiver 13 as the at least one second reverse link, independent of an assignment of a transmitter, to form at least one simplex reverse link in communication with the communication device.

16. The method of claim 15, wherein the determining further includes retrieving information representative of the quality from storage, where the communication device is in communication with at least one receiver that is not in an active set sector.

17. The method of claim 15, wherein the determining further comprises scanning the communication device to measure the quality, where the communication device is in communication with at least one receiver that is not in an active set sector.

18. The method of claim 15, further comprising forming at least one second duplex link to communicate with the communication device, the second duplex link utilizing the at least one simplex reverse link.

19. The method of claim 15, further comprising signaling at least a second base station to indicate an availability of the at least one simplex reverse link.

20. The method of claim 15, further comprising signaling at least a second base station to request an assignment of at least a second simplex reverse link on the second base station.

21. A computer-readable medium comprising instructions being executed by a computer, the instructions including a computer-implemented method for managing a communication environment for communicating with communication devices utilizing duplex links, where a duplex link includes a forward link corresponding to a transmitter and a reverse link corresponding to a receiver, the instructions for implementing the steps of:
(A) first assigning at least one receiver of a plurality of receivers as at least one simplex reverse link;
(B) second assigning the at least one simplex reverse link to a communication device;
(C) transmitting a communication to the communication device on a duplex link; and
(D) receiving a signal from the communication device on the at least one simplex reverse link.

22. The medium of claim 21, wherein the signal is further received on the at least one simplex reverse link and the reverse link of the duplex link, further comprising instructions for implementing the step of combining the signals received from the communication device on the at least one simplex reverse link and the reverse link of the duplex link.

23. The medium of claim 21, further comprising instructions for implementing a step of providing the duplex link, including assigning at least one transmitter of a plurality of transmitters as at least one forward link, and assigning at least one other receiver of the plurality of receivers as a duplex reverse link.

24. The medium of claim 21, further comprising instructions for implementing a step of determining a quality of a signal from the communication device, wherein the second assigning is responsive to the quality.

25. The medium of claim 21, further comprising instructions for implementing a step of adding, responsive to a handoff of the communication device, a forward link to the at least one simplex reverse link, to form a second duplex link to the communication device.
